(19) United States
(12) Patent Application Publication
(10) Pub. No.: US 2017/0187101 A1
(43) Pub. Date: Jun. 29, 2017

(54) DEVICE SYSTEM AND METHOD FOR PROVIDING MOBILE SATELLITE COMMUNICATION

(71) Applicants: Tom Freeman, Redmond, WA (US); David Fotheringham, Redmond, WA (US); Mersad Cavcic, Redmond, WA (US); Adam Nonis, Redmond, WA (US); Tom Hower, Redmond, WA (US)

(72) Inventors: Tom Freeman, Redmond, WA (US); David Fotheringham, Redmond, WA (US); Mersad Cavcic, Redmond, WA (US); Adam Nonis, Redmond, WA (US); Tom Hower, Redmond, WA (US)

(21) Appl. No.: 15/377,936

(22) Filed: Dec. 13, 2016

Related U.S. Application Data
(60) Provisional application No. 62/387,471, filed on Dec. 23, 2015.

(51) Int. Cl. H01Q 1/32; H01Q 1/22; H01Q 1/48; H01Q 3/24

(52) U.S. Cl. CPC H01Q 1/3275; H01Q 3/24; H01Q 1/2291; H01Q 1/48

(57) ABSTRACT

Techniques and mechanisms to provide a motor vehicle with connectivity for satellite communications. In an embodiment, a communication device is disposed between an exterior surface of the motor vehicle and an interior surface of the motor vehicle. An antenna panel, disposed in a housing of the communication device, may be configured to participate in satellite communication via a first side of the communication device. A configuration of the antenna panel, the housing or one or more hardware interfaces of the communication device may facilitate low profile solution for such communication with the satellite. In another embodiment, the one or more hardware interfaces are each disposed on a respective side of the housing other than the first side, the one or more hardware interfaces to couple the communication device to a power supply of a motor vehicle.

### CROSS-REFERENCE TO RELATED APPLICATIONS

This application claims the benefit of U.S. Provisional Application No. 62/387,471, filed on Dec. 23, 2015, the entire contents of which are hereby incorporated by reference herein.

### BACKGROUND

1. Technical Field

Embodiments of the present invention relate to the field of antennas and more particularly, but not exclusively, relate to an antenna for operation in an automobile.

2. Background Art

As wireless communication technologies continue to grow in number, variety and capability, there is an increasing demand for the automotive industry to provide new communication solutions that challenge existing markets for consumer smartphones and in-vehicle cellular technology modules. Typically, existing in-vehicle wireless communication technologies are variously limited by low data throughput, lack of addressability, large expense, high power requirements, lack of scalability and/or excessive weight or size.

Currently, shark-fin antennas, which are attached to the outside of vehicles, provide a limited data throughput that can accommodate little more than audio streaming—e.g., for amplitude modulation (AM) radio, frequency modulation (FM) radio or satellite radio. While such solutions tend to be low power and inexpensive, such audio-only services do not compete with Long Term Evolution (LTE) technology data rate performance of smartphones and cellular communication technologies.

Some cellular modem-based in-vehicle services exist, and usually leverage second generation to fourth generation cellular networks. Although the existing cellular network architecture immensely helps with cost points, service availability is limited to markets with mature infrastructure, and, where available, duplicates services that often already exist in a passenger's smartphone.

For commercial and governmental applications, military customers have integrated multi-role electronically scanned array (MESA) and active electronically scanned array (AESA) solutions into their Humvees and other military vehicles to provide communications-on-the-move (COTM) and communications-on-the-pause (COTP). Although such technologies provide high throughput links with low probability of detect and low probability of intercept, they have enormous price points and extremely high power requirements. Some COTM and COTP solutions, which use gimbaled dishes to provide needed agility and performance, are usually so large and bulky that they can only be installed on larger vehicles.

### BRIEF DESCRIPTION OF THE DRAWINGS

The various embodiments of the present invention are illustrated by way of example, and not by way of limitation, in the figures of the accompanying drawings and in which:

FIG. 1A is a side-view diagram illustrating elements of a system to provide satellite communication according to an embodiment.

FIG. 1B is an exploded view diagram illustrating elements of a device to facilitate satellite communication according to an embodiment.

FIG. 2 is a flow diagram illustrating elements of a method for providing satellite communication functionality according to an embodiment.

FIG. 3A is a perspective view diagram illustrating elements of a device to facilitate satellite communication according to an embodiment.

FIG. 3B is a functional block diagram illustrating elements of a device to enable satellite communication according to an embodiment.

FIG. 4A is a perspective view diagram illustrating elements of a system to participate in a communication via satellite according to an embodiment.

FIGS. 4B, 4C are cross-sectional diagrams each illustrating elements of respective communication system according to a corresponding embodiment.

FIGS. 5A-5C are diagrams each showing views of a respective communication system according to a corresponding embodiment.

FIGS. 6A and 6B illustrate side views of respective cylindrically fed antenna structures each according to a corresponding embodiment.

FIG. 7 is a top view of an antenna panel of a communication device according to an embodiment.

FIG. 8 is a side view diagram showing features of an antenna panel to facilitate satellite communication according to an embodiment.

FIG. 9 is a top view diagram showing features of an antenna panel to facilitate satellite communication according to an embodiment.

FIG. 10 is a perspective view showing features of an antenna panel to facilitate satellite communication according to an embodiment.

FIG. 11 is a cross-sectional view diagram showing features of an antenna panel to facilitate satellite communication according to an embodiment.

FIG. 12 is a block diagram illustrating features of a communication system according to an embodiment.

### DETAILED DESCRIPTION

Embodiments described herein variously provide efficient solutions to enable satellite communications with an in-vehicle platform. In some embodiments, a communication device includes one or more antenna elements that enable high throughput communications with an in-orbit satellite. The one or more antenna elements may accommodate satellite communications that are according to a communication protocol—such as a Transmission Control Protocol/Internet Protocol (TCP-IP), User Datagram Protocol (UDP) or the like—that, for example, accommodates digital data exchanges via an Internet. Alternatively or in addition, such satellite communications may be simplex, half-duplex or full duplex, for example. A bandwidth supported by the one or more antenna elements may be sufficient for applications with higher throughput requirements than those for audio streaming—e.g., wherein the one or more antenna elements operate to facilitate software updates, high definition video streams and/or the like.

Some or all such one or more antenna elements may provide holographic antenna functionality and/or may be integrated with a planar structure (referred to herein as an “antenna panel”) that accommodates a low-profile form factor. Accordingly, a communication device which includes such an antenna panel may be conformal to a portion of the vehicle (e.g., a roof) to which the communication device is attached. In one example embodiment, some or all of the antenna panel is fabricated using a thin film transistor (TFT) manufacturing process. Alternatively or in addition, the antenna panel may provide for an electronically steerable transmit and/or receive functionality.

Some features of various embodiments are described herein with reference to a communication device that is configured to operate in an automobile (e.g., a car, truck, bus, tractor or other such construction equipment). However, such description may be extended to apply to operation of such a communication device in train, a boat and/or any of a variety of other motor vehicles.

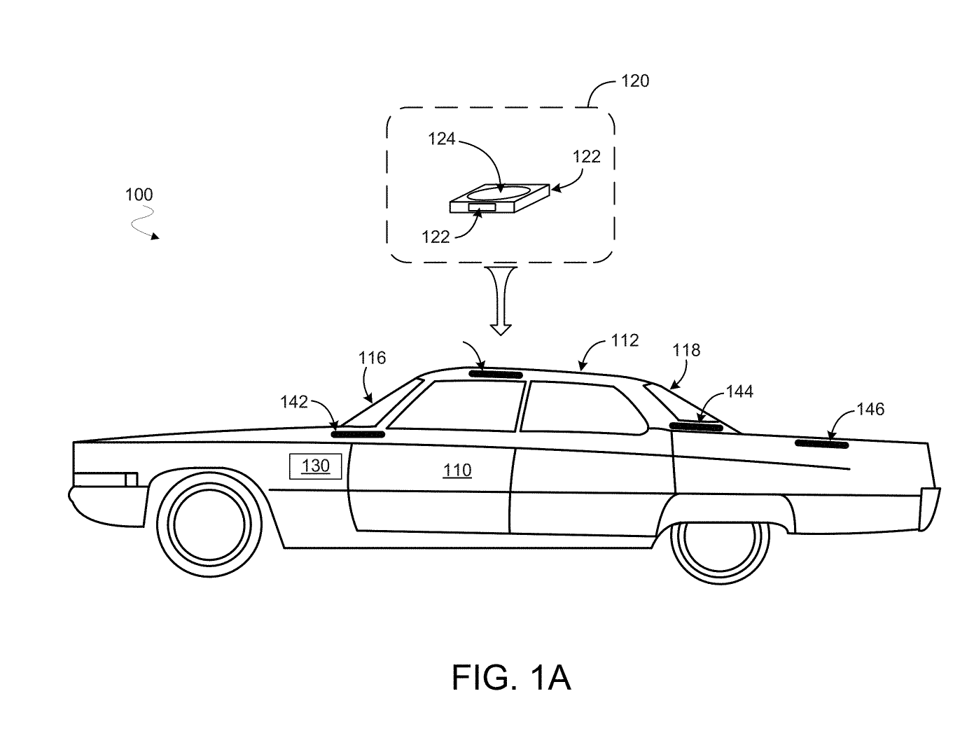

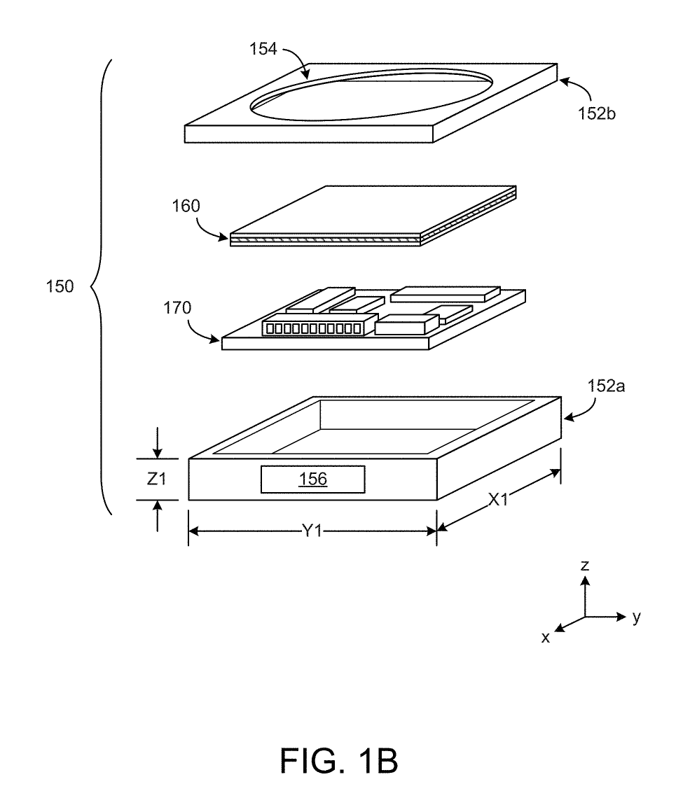

FIG. 1A illustrates elements of a system 100 to enable satellite communication according to an embodiment. System 100 is just one example of an embodiment wherein a communication device is configured to operate in a motorized vehicle (e.g., based on power which is supplied to the communication device from the vehicle), the communication device enabling communication with an in-orbit satellite.

For example, system 100 may comprise a vehicle 110 (in the illustrative embodiment shown, an automobile) having disposed therein a communication device 120 to facilitate communication with a satellite (not shown) that is part of, or otherwise communicatively coupled to, system 100. Vehicle 110 may include or be coupled to circuitry 130 that is configured to facilitate operation with device 120. For example, circuitry 130 may include a power source (e.g., providing 12V DC) to provide a supply voltage to device 120. Alternatively or in addition, circuitry 130 may communicate signals representing data received from a satellite, signals representing data to be sent to a satellite, signals to configure device 120, signal to indicate an operating condition of device 120 and/or the like.

In one embodiment, device 120 is located under an exterior surface of a roof portion 112 of vehicle 110. However, device 120 may instead be located at any of a variety of other locations of device 110 (e.g., between an interior surface of vehicle 110 and an exterior surface of vehicle 110). By way of illustration and not limitation, a communication device may be located at a region 142 which is on or under a front dashboard which, in turn, is under a front windshield 116 of vehicle 110. Alternatively or in addition, a communication device may be located at a region 144 which is on or under a rear dashboard which, in turn, is under a rear windshield 118 of vehicle 110. In various embodiments, a communication device may additionally or alternatively be located in a region 146 under a trunk lid of vehicle 110. Although some embodiments are not limited in this regard, system 100 may further comprise one or more additional communication devices (not shown) variously located in vehicle 100, where the one or more additional communication devices are to participate in satellite communicates in combination with communication device 120.

Device 120 is one example of an embodiment comprising low-profile structures that support satellite communication. For example, device 120 may include a housing 122 and an antenna panel 124 including one or more antenna elements disposed in a volume that is defined at least in part by housing 120. One or more hardware interfaces of device 120 (e.g., including the illustrative interface 122 shown) may facilitate coupling of device 120 to circuitry 130 and/or a communication performed with antenna panel 124. Housing 122 may span a thickness, along a first line of direction, of not more than 5.0 inches (e.g., wherein the thickness is equal to or less than 4.0 inches). In such an embodiment, the housing 122 may span a cross-sectional area—in a plane that is orthogonal to the first line of direction—of at least 30 square inches (e.g., wherein the cross-sectional area is equal to or more than 50 square inches).

FIG. 1B shows features of a device 150 to facilitate satellite communications according to an embodiment. Device 150 may include some or all of the features of device 120, for example. Device 150 is one example of an embodiment including a housing which surrounds a volume—e.g., in at least one plane—wherein an antenna panel is disposed in said volume. The configuration of housing and antenna panel and/or other structures may facilitate a low-profile solution for satellite communication in a vehicle (such as vehicle 110). For example, communication device 150 may be adaptable for mounting under an exterior surface of a vehicle to provide a mobile satellite communications terminal that is more mobile, lower visibility, lower power and/or lower cost, as compared to other satellite communication technologies. In such an embodiment, communication device 150 may provide little or no visible protrusion from, or deformation in, a desired aesthetic of the vehicle.

In the example embodiment shown, device 150 includes a housing formed, for example, by portions (e.g., including the illustrative housing portions 152a, 152b shown) that meet to surround at least part of an antenna panel 160. The housing may comprise any of a variety of plastic, metal or other materials used in laptops, tablets etc. to protect and structurally support circuit components.

Antenna panel 160 may comprise one or more antenna elements operable to participate in a satellite communication—e.g., on behalf of an in-vehicle network. Such communication may, for example, include antenna panel 160 communicating signals in a frequency range which includes frequencies greater than 7.5 GigaHertz (GHz)—e.g., wherein the frequency range includes at least 10 GHz. By way of illustration and not limitation antenna panel 160 may communicate Ku band signals (in a 12 GHz to 18 GHz range), Ka band signals (in a 26.5 GHz to 40 GHz range), Q band signals (in a 33 GHz to 50 GHz range), V band signals (in a 40 GHz to 75 GHz range) or the like. Alternatively or in addition, communications with antenna panel 160 may include transmission or reception of signals representing TCP-IP packets and/or any of a variety of other packetized data which is compatible with an Internet communication protocol.

Antenna panel 160 may include some or all of an electronically steerable antenna array that, for example, provides configurable holographic antenna functionality and/or is fabricated utilizing a thin-film transistor (TFT) manufacturing process. For example, the antenna panel 160 may function as a holographic antenna that (as compared to phased array antennas, for example) enables relatively low-power operation and/or outputs less heat during such operation. By way of illustration and not limitation, satellite communication may be powered by a universal serial bus (USB) connection—e.g., compatible with the USB 2.0 standard, USB 3.0 standard or USB 3.1 standard developed by the USB Implementers Forum (USB IF)—coupled between antenna panel 160 and circuitry 130. TFT processes may allow for a reduction of overall depth of antenna structures—e.g., as compared to thicknesses seen in other antenna technologies. Alternatively or in addition, such antenna structures may provide high throughput connectivity solution (e.g., to support broadband data rates) and/or may have relatively low power requirements. Embodiments which provide low profile, low power, low heat and/or high throughput solutions may be particularly well suited to operation in a confined space (e.g., not more than five inches thick) of a vehicle.

Although some embodiments are not limited in this regard, communication of such signals may result in, or be based on, additional communications between device 150 and another device in the same vehicle. For example, communication device 150 may facilitate wired communication and/or wireless communication with circuitry integrated into a console of the vehicle. Alternatively or in addition, communication device 150 may support wireless communication with a smart phone, tablet or other mobile device that is located in the vehicle. In some embodiments, communication device 150, or another device which is integrated into the vehicle, will act as a hub for communications to be exchanged with a user's mobile device.

Device 150 may further comprise circuitry 170 coupled to enable operation of antenna panel 160. By way of illustration and not limitation, circuitry 170 may include one or more printed circuit boards having passive circuit components and/or active circuit components (e.g., including one or more integrated circuit packages) variously disposed therein or thereon. One or more interfaces of device 150—e.g., including the illustrative hardware interface 156 shown—may include hardware connector structures to facilitate coupling of device 150 to an external power supply (not shown) such as at circuitry 130 of vehicle 110. A supply voltage provided by such a power supply may directly power operation of circuitry 170 and/or may charge a battery (not shown) which is included in or coupled to supply circuitry 170. Circuitry 170 may further comprise one or more components to facilitate wired communication and/or wireless communication between device 150 and another device (not shown) in the vehicle. For example, the one or more interfaces may include a connector to couple to a waveguide for communicating a signal to or from antenna panel 160. Alternatively or in addition, the one or more interfaces may communicate packetized digital data which is based on (or is to be converted into) an analog signal received by (or to be transmitted by) antenna panel 160.

Antenna panel 160 and/or other structures of device 150 may enable operation of device 150 while it is disposed in a vehicle (such as vehicle 110). For example, device 150 may be coupled to operate while secured or otherwise positioned between an exterior surface of the vehicle and an interior liner that, for example, is light weight and/or conformal at least in part with an overhead interior side of a roof or other such structure. Such a liner structure—e.g., including a plastic, particle board, upholstery, metal or the like—may provide insulation to the vehicle from an exterior environment, and may cover some or all of device 150—e.g., where device 150 is not exposed to an interior cabin of the vehicle.

To illustrate some low-profile characteristics of certain embodiments, example dimensions (not necessarily to scale) of device 150 are identified with reference to a x, y, z coordinate system—e.g., wherein device 150 spans a width X1 along a x-axis, a length Y1 along a y-axis and a height Z1 along a z-axis. In such an embodiment, the height Z1 may, for example, be equal to or less than 5.0 inches—e.g., wherein Z1 is less than 4.0 inches and, in some embodiments, less than 2.0 inches. The height Z1 may, for example, be less than 1.5 inches, in some embodiments (e.g., wherein Z1 is between 1.2 inches and 0.45 inches). Alternatively or in addition, a ratio of a cross-sectional area of device 150 to Z1 (e.g., the cross-sectional area equal to a product of X1 and Y1) may be greater than Z1—e.g., wherein the ratio is at least fifty percent (50%) greater than Z1 and, in some embodiments, greater than twice Z1. For example, such a ratio may be greater than four times Z1—e.g., wherein the ratio is at least six times Z1.

Low-profile characteristics of device 150 may additionally or alternatively be facilitated by the location of one or more hardware interfaces such as interface 156. For example, some or all such hardware interfaces may be variously located each on a respective side of device 150 other than a side via which antenna panel 160 communicates with a satellite. For example, such one or more interfaces may variously face in a respective direction that is substantially parallel to (e.g., within 10° of) the x-y plane shown. Such an arrangement of any or all hardware interfaces may allow for a top side of the housing being closer to (e.g., flush with) an exterior structure of the vehicle.

In the illustrative embodiment shown, antenna panel 160 is aligned with an aperture structure 154 which is formed (e.g., by housing portion 152b) at a side of the housing, the aperture structure 154 to accommodate signal communication, via said side of the housing, between antenna panel 160 and a remote satellite (not shown). Some or all of this side of the housing may extend in the x-y plane shown—e.g., wherein at least a portion of the side is parallel to the x-y plane. In some embodiments, the housing forms, or is configured to couple to, a radome structure (not shown) which is at least partially transparent to signals to or from antenna panel 160. Such a radome may provide antenna panel 160 with environmental protection and/or may mitigate distortion of a radiated signal pattern. The structure of the radome—e.g., including its composition, thickness or shape—may mitigate absorptive loss in the radome and/or signal reflections returning to antenna panel 160. In an embodiment, the radome includes one or more materials having low dielectric constant and low loss tangent properties. Any of a variety of materials used in conventional radome design may be adapted into some embodiments. Examples of such materials include, but are not limited to, any of a variety of thermoplastics (e.g., polycarbonate, polystyrene, polyetherimide, etc.), fiber reinforced composites (e.g., E glass fabric with epoxy or polyester resins), and low dielectric glass (monolithic or laminated). However, some embodiments are not limited to a particular type of radome shape and/or radome material.

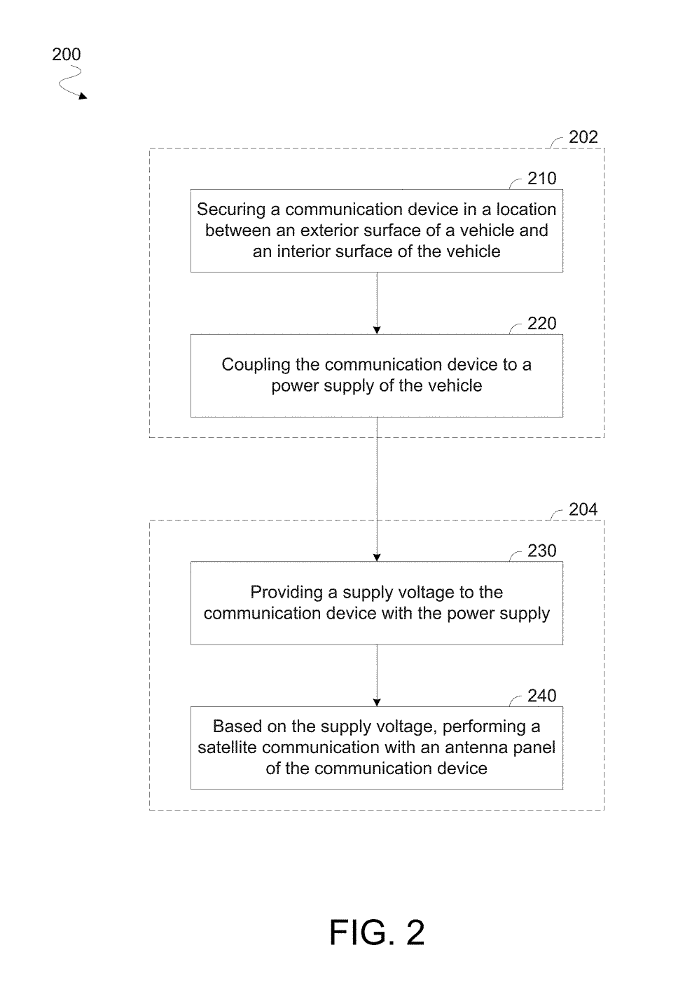

FIG. 2 shows operations that may be included in a method 200 to provide functionality for satellite communication according to an embodiment. Method 200 may include or otherwise enable operation of system 100, for example. In one embodiment, method 200 provides communication functionality with one of communication devices 120, 150.

In some embodiments, method 200 includes operations 202 to configure a communication device for operation in a motor vehicle. For example, operations 202 may include, at 210, securing a communication device in a location between an exterior surface of a vehicle and an interior surface of the vehicle. The securing may include placing the communication device in a recess, cavity, hole or other structure that is formed at least in part by structures of the vehicle that adjoin or otherwise form an interior cabin space. Such a cavity, recess, hole or other structure may be distinct from a cabin region of the vehicle, where the cabin region is to accommodate a passenger or an operator of the vehicle. In some embodiments, the securing includes placing over the communication device a panel that is to function as a radome. Operations 202 may further comprise, at 220, coupling the communication device to a power supply of the vehicle. For example, a cable or other interconnect may extend between the power supply and the communication device—e.g., wherein the interconnect is under a liner material or otherwise hidden from view.

In some embodiments, operations 202 further comprise coupling the communication device to one or more signal lines of the vehicle. Some or all such signal lines may thus be configured to facilitate communication between the communication device and circuitry of the vehicle that, for example, is to function as a source of digital signals and/or a sink of digital signals. For example, data source circuitry of the vehicle may provide to the communication device digital data which is then to be processed and converted to an analog signal for transmission to a satellite.

In some embodiments, operations 202 comprise coupling the communication device to a waveguide of the vehicle. The waveguide may thus be coupled to communicate an analog signal which is to be transmitted by an antenna panel of the communication device. Alternatively or in addition, the waveguide may be coupled to receive from the communication device an analog signal received with such an antenna panel.

In some embodiments, method 200 additionally or alternatively includes operations 204 to operate a communication device such as one which is configured, for example, by some or all of operations 202. For example, operations 204 may include, at 230, providing a voltage to the communication device with the power supply of the vehicle. In some embodiments, operations 204 further comprise (at 240) performing a satellite communication, based on the supply voltage, with an antenna panel of the communication device

Referring again to FIG. 1B, device 150 may receive—e.g., from circuitry 130 of vehicle 110—power that then is applied to circuitry 170 to enable operation of antenna panel 160. By way of illustration and not limitation, circuitry 170 may include some or all of a modem, antenna controller, and transceiver circuitry. In such an embodiment, the modem may convert internet protocol information (for example), provided by the vehicle, into a format which is compatible with a satellite communication protocol. The resulting formatted signal may be amplified through the transceiver and converted by the antenna panel into radio wave energy that is then transmitted from the vehicle.

Alternatively or in addition, radio wave energy from a satellite may be received via the antenna panel and down converted to a signal which is compatible with the satellite protocol. Such a converted signal may be provided to the modem—e.g., for demodulation, conversion into an IP protocol and/or the like prior to communication to a sink which is part of or otherwise located in the vehicle.

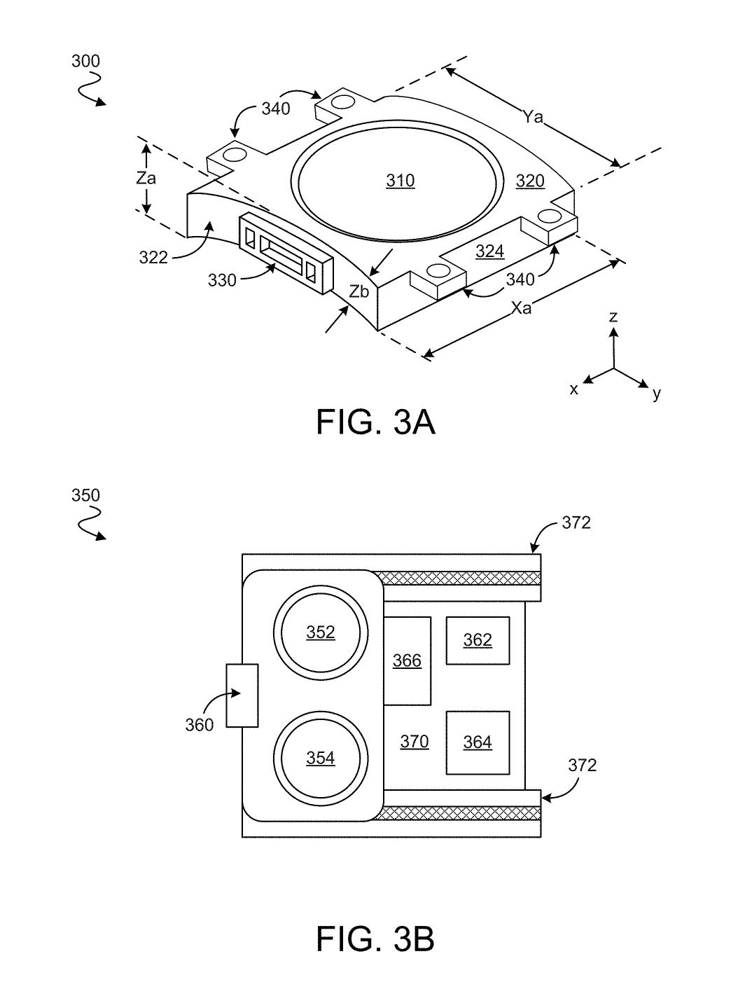

FIG. 3A illustrates a device 300 to provide satellite communication according to an embodiment. Device 300 may have some or all of the features of one of devices 120, 150, for example. In an embodiment, one or more operations of method 200 include or otherwise enable operation of device 300.

Device 300 is one example embodiment wherein an antenna panel, housing and/or other structure is sufficiently thin to readily accommodate low-profile installation/operation in a vehicle. In the illustrative embodiment shown, device 300 includes a housing and an antenna panel 300 that is located between various sides (e.g., including the illustrative sides 320, 322, 324) of the housing. To illustrate certain low-profile characteristics of various embodiments, dimensions (not necessarily to scale) of device 300 are identified with reference to a x, y, z coordinate system—e.g., wherein device 300 spans a width Xa along a x-axis, a length Ya along a y-axis and a height Za along a z-axis. In such an embodiment, the height Za may, for example, be less than 4.0 inches—e.g., wherein Za is less than 2.0 inches and, in some embodiments, less than 1.0 inch. The height Za may, for example, be less than 0.8 inches. Alternatively or in addition, a ratio of a cross-sectional area of device 300 to Za (e.g., the cross-sectional area equal to a product of Xa and Ya) may be greater than Za—e.g., wherein the ratio is at least fifty percent (50%) greater than Za and, in some embodiments, greater than twice Za.

Such low-profile characteristics of device 300 may be facilitated at least in part by structures of antenna panel 310, which (for example) may comprise a reconfigurable metamaterial operable to provide a holographic antenna functionality. As compared to other satellite communication technologies such an antenna functionality may be relatively flat, thin and/or lower power.

Additionally or alternatively, low-profile characteristics of device 300 may be facilitated at least in part by the location of one or more connector structures of device 300, where such connector structures are to facilitate mechanical and/or communicative coupling with structure of a vehicle (not shown). For example, one or more hardware interfaces of device 300 (e.g., including the illustrative interface 330 shown) may each be coupled to a respective side of the housing other than a first side 320 via which antenna panel 310 is to communicate with a remote satellite. In some embodiments, any hardware interface of device 300 which is to enable delivery of power or signals is located on a respective side other than such a first side.

In some embodiments, a communication device further includes one or more mounting structures—e.g., including any of a variety of brackets, slots, clips, rails, tabs, holes, threading and/or the like—to facilitate a securing of the communication device under or on an adjoining structure of a vehicle. By way of illustration and not limitation, the housing of communication device 300 may form various brackets 340 which enable coupling to an interior surface of such a vehicle. Some of all of brackets 340 may form respective through-holes each to receive corresponding pin, screw or other alignment structure—e.g., to aid alignment of communication device 300 in a recess, hole or other structure formed by the vehicle.

In some embodiments, a low-profile of device 300 is further facilitated by a curvature of the housing. In the example embodiment shown, a portion of side 320 may extend in (or at least in parallel with) the x-y plane shown, wherein another portion of side 320 curves to/from the x-y plane, thus allowing a center of mass of device 300 to be relatively closer to an overhanging surface (not shown) of the vehicle. Alternatively or in addition, a lower side of the housing (opposite 320) may curve to/from the x-y plane—e.g., wherein a height Zb of device 300 at one location is less than the overall height Za. Such curvature may allow an interior liner structure (not shown) of the vehicle to conform to a desired aesthetic.

FIG. 3B shows a cross-sectional top view of a device 350 to provide satellite communication according to an embodiment. Device 350 may have one or more features of one of devices 120, 150, 300, for example. In an embodiment, method 200 includes or otherwise facilitates operation of device 350. Although some embodiments are not limited in this regard, device 300 may function as a retrofit sunroof tray assembly, for example.

In the illustrative embodiment shown, device 350 includes one or more antenna panels (e.g., including the illustrative antenna panels 352, 354 shown) and circuit components (e.g., of circuitry 170) to facilitate operation of such one or more antenna panels. A hardware interface 360 may facilitate coupling of device 350 to a circuitry of a vehicle (not shown) which is to provide one or more voltage for powering operation of such circuitry.

In an embodiment, a printed circuit board 370 of device 300 may have disposed thereon some or all of a block up converter (BUC), down converter (such as a low-noise block, or “LNB,” downconverter), encoder, decoder, modulator, demodulator, control logic, modem circuitry (for wired communication and/or wireless communication), memory resources and/or the like. For example, a BUC and/or a LNB converter—e.g., the illustrative converter logic 366 shown—may be coupled to some or all of the one or more antenna panels via a waveguide structure (not shown). In such an embodiment, converter logic 366 may be coupled to a modulation and/or demodulation module (e.g., the illustrative modulation logic 362 shown) which is to provide at least in part a conversion between an analog communication format and a digital communication format. Encoder circuitry and/or decoder circuitry may provide for conversion of data to and/or from a data format such as one that is compatible with TCP-IP, UDP or other such Internet communication protocol.

One or more operations of device 300 may be controlled by circuitry such as the illustrative controller 364 shown. Such one or more operations may include, but are not limited to, a tuning of a communication frequency and/or a steering of a transmit or receive functionality provided at a given antenna panel. Alternatively or in addition, such one or more operations may include configuring an operational mode of device 350 in response to command signals from the vehicle, communication of device state back to the vehicle, detecting the presence of a mobile device with which wireless communications may be performed, etc.

The circuitry and antenna panels 352, 354 may be variously located in a housing which, for example, forms rails 372 (or other such mounting structure) to facilitate coupling of device 350 in a motor vehicle. By way of illustration and not limitation, device 350 may accommodate being located in a space into which a vehicle's sunroof cover might otherwise retract when the sunroof is open. Such a space may instead be used to accommodate device 350 and, in some embodiments, an interconnect to couple device 350 to a power supply. In such an embodiment, a liner may be installed in the vehicle to hide device 350, mounting hardware, the interconnect and/or the like.

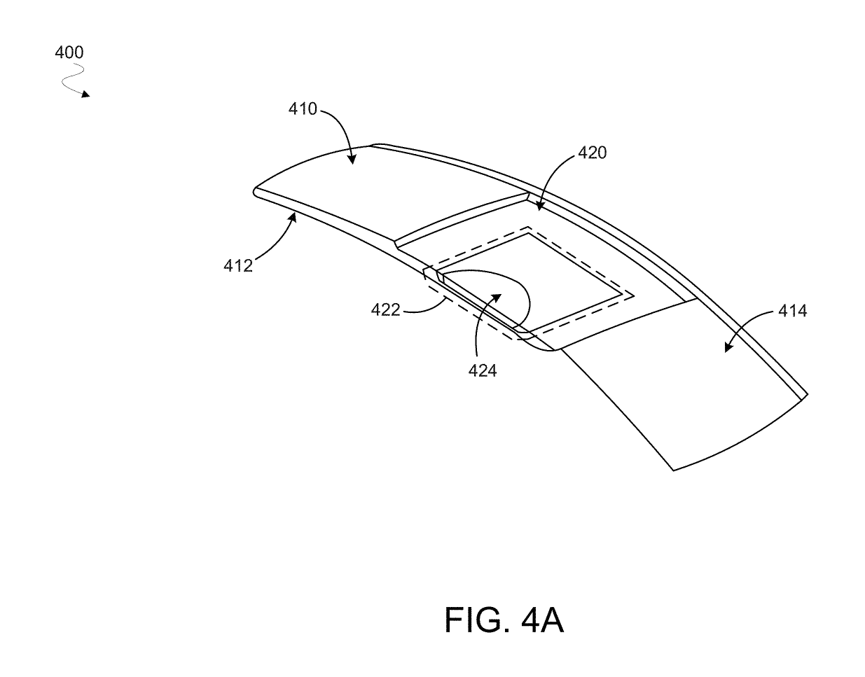

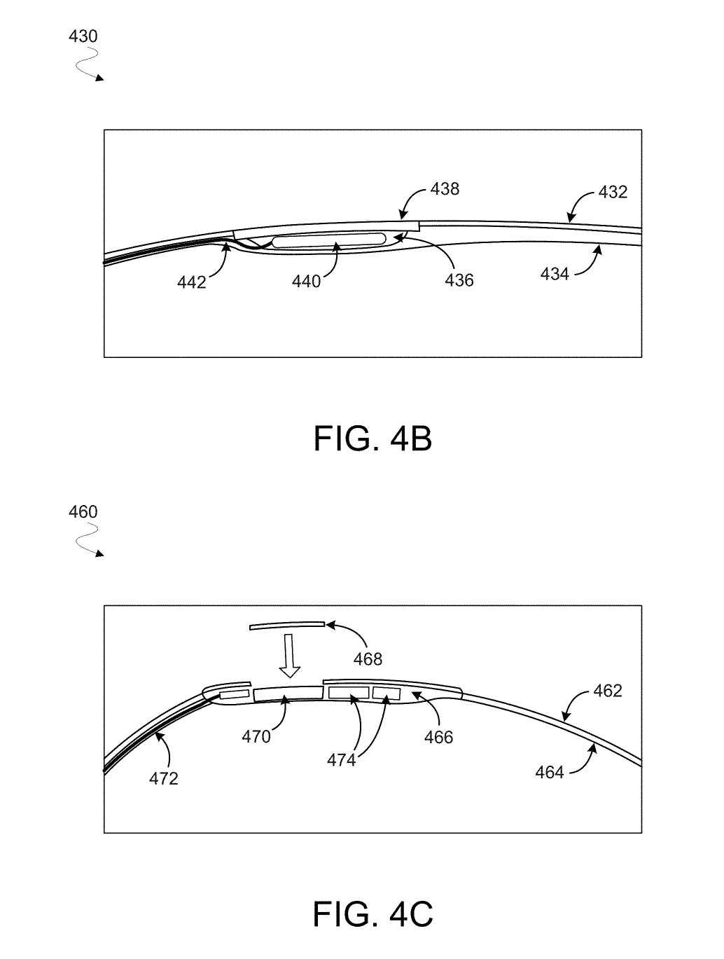

FIG. 4A shows, in a cut-away view, features of a system 400 to provide satellite communication according to an embodiment. System 400 may include some or all of the features of system 100, for example. In one illustrative embodiment, some or all of method 200 includes or otherwise provides for operation of system 400.

System 400 may include a vehicle and a communication device 422—e.g., having features of one of devices 120, 150, 300, 350—located between an exterior surface 410 of the vehicle and an interior surface 412 of the vehicle. For example, a roof structure and a liner of the vehicle may form surfaces 410, 412, respectively—e.g., wherein a windshield 414 of the vehicle adjoins the roof structure. Communication device 422 may be positioned in or under a recess 420 which extends at least in part past the exterior surface 410. In such an embodiment, an antenna panel 424 of communication device 422 may face through an aperture structure toward recess 420. In such an embodiment, a radome structure (not shown) may be inserted into recess 420 to provide protection to antenna panel 424, wherein the radome structure is at least partially transparent to signals communicated between antenna panel 424 and a remote satellite.

FIG. 4B shows, in a cross-sectional side view, features of a system 430 to provide satellite communication according to another embodiment. System 430 may include some or all of the features of system 100, for example. In one illustrative embodiment, some or all of method 200 includes or otherwise provides for operation of system 430.

System 430 may include a vehicle and a communication device 440 (having features of device 120, for example) located between an exterior surface 432 of the vehicle and an interior surface 434 of the vehicle—e.g., wherein a roof and a liner of the vehicle form surfaces 432, 434, respectively. Communication device 440 may be positioned in or under a recess 436 which extends at least in part past the exterior surface 432. In such an embodiment, communication device 440 may be positioned to communicate (e.g., transmit and/or receive) signals with a remote satellite through a curved plane to which exterior surface 432 conforms. For example, such signals may propagate through a radome 438 that covers recess 436 and communication device 440 at least in part. In some embodiments, and interconnect 442 couples communication device 440 to a power supply (not shown) of the vehicle—e.g., wherein interconnect 442 extends along a door frame, windshield post and/or other structure of a vehicle body. The interconnect 442 may be hidden from view behind a liner structure of the vehicle.

FIG. 4C shows, in a cross-sectional side view, features of a system 460 to provide satellite communication according to another embodiment. System 460 may include some or all of the features of system 100, for example. In one illustrative embodiment, some or all of method 200 includes or otherwise provides for operation of system 460.

A communication device of system 460 may include an antenna panel 470 and circuit components 474 (e.g., of circuitry 170) variously located in a cavity 466 formed between an exterior surface 462 of the vehicle and an interior surface 464 of the vehicle. Such a communication device may have some or all features of device 120 and/or may function as a retrofit sunroof assembly, for example. The antenna panel 470 may communicate (e.g., transmit and/or receive) signals with a remote satellite—e.g., through a radome 468 that, for example, is removably attached as an after-market component of system 460. Operation of antenna panel 470 may be based on a supply voltage which the vehicle provides via an interconnect 472 to the communication device—e.g., wherein interconnect 472 is hidden from view behind interior surface 434.

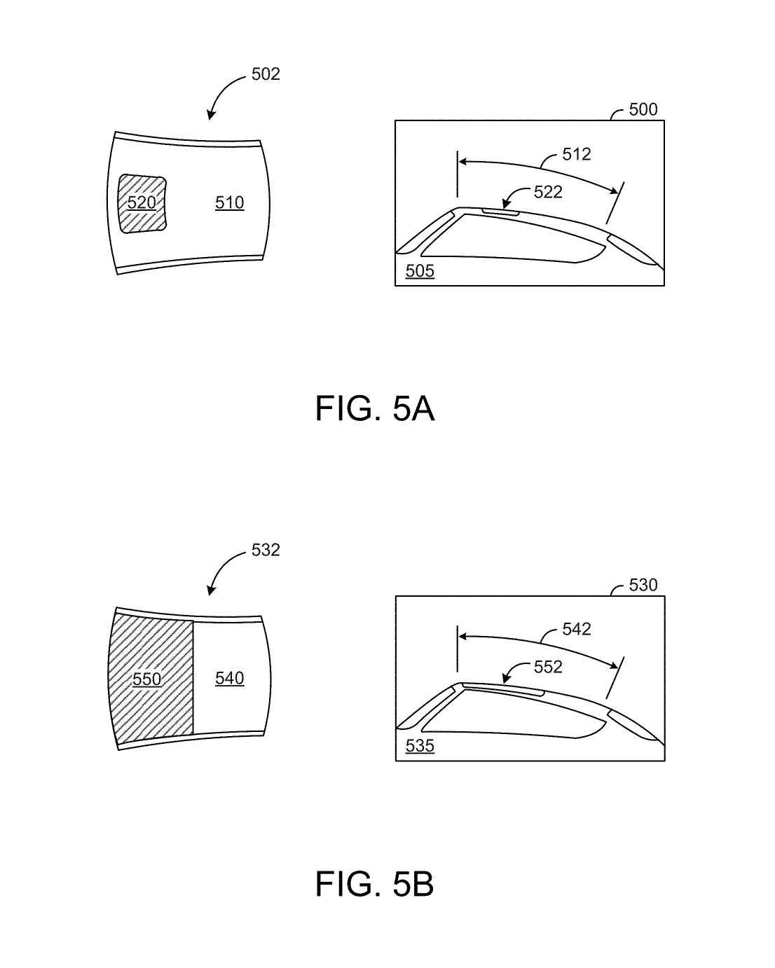

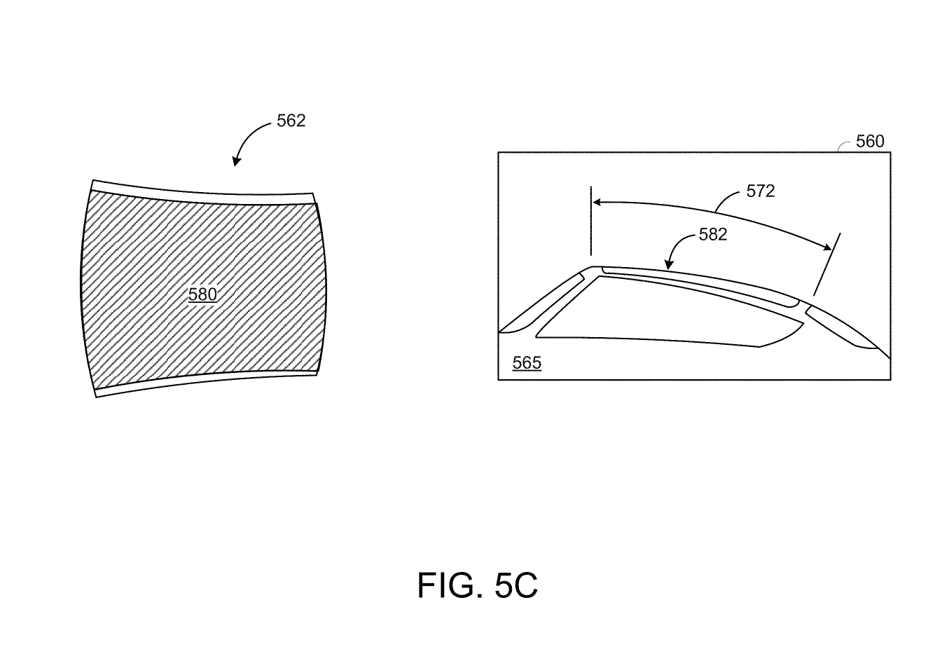

FIGS. 5A-5C variously show systems 500, 530, 560 each to communicate with a respective satellite according to a corresponding embodiment. Some or all of systems 500, 530, 560 may each include respective features of one of systems 100, 400, 430, 460, for example—e.g., wherein functionality of such a system is provided according to method 200. As illustrated in FIGS. 5A-5C, the area of an antenna panel may vary depending on application. In some applications, a larger antenna may be used that extends across several square inches of space under an exterior surface of the vehicle, such as an entire rear section of a roof.

For example, the system 500 show in FIG. 5A may comprise a vehicle 505 including a roof portion 512 in which is disposed a radome structure 522. As shown in the top side cut-away view 502 of system 500, a communication device 520 (e.g., one of devices 120, 150, 300, 350, etc.) under radome 522 may be confined to an interior region under a surface 510 of roof portion 512. In another embodiment shown in FIG. 5B, system 530 comprises a vehicle 535 including a roof portion 542 in which is disposed a radome structure 552. As shown in the top side cut-away view 532 of system 530, a communication device 550 under radome 552 may extend to a region under one or more—e.g., but not all—edges of a surface 540 of roof portion 542. In the example embodiment shown, communication device 550 extends to a region under half of surface 540. In still another embodiment shown in FIG. 5C, system 560 comprises a vehicle 565 including a roof portion 572 in which is disposed a radome structure 582. As shown in the top side cut-away view 562 of system 560, a communication device 580 under radome 582 may extend under substantially all of roof portion 572 (e.g., at least 90% of an area under roof portion 572).

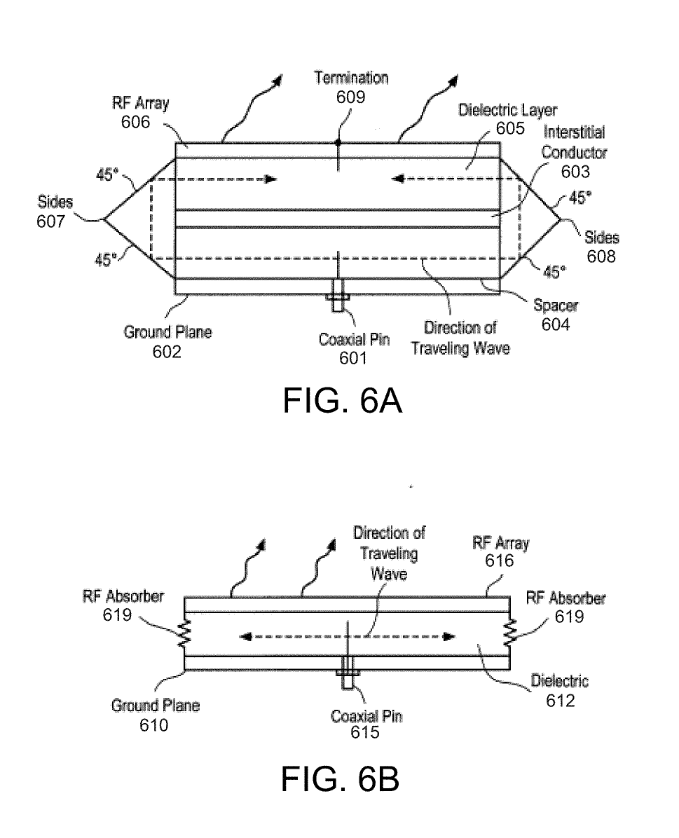

FIG. 6A illustrates a side view of a cylindrically fed antenna structure to enable satellite communication according to an embodiment. One of antenna panels 124, 160, 310, 352, 354, etc. may include the antenna structure shown in FIG. 6A, for example. The antenna may produce an inwardly travelling wave using a double layer feed structure (i.e., two layers of a feed structure). In one embodiment, the antenna includes a circular outer shape, though this is not required.

Referring to FIG. 6A, a coaxial pin 601 may be used to excite the field on the lower level of the antenna. In one embodiment, coaxial pin 601 is a 500 coax pin. Coaxial pin 601 may be coupled (e.g., bolted) to the bottom of the antenna structure, which is conducting ground plane 602.

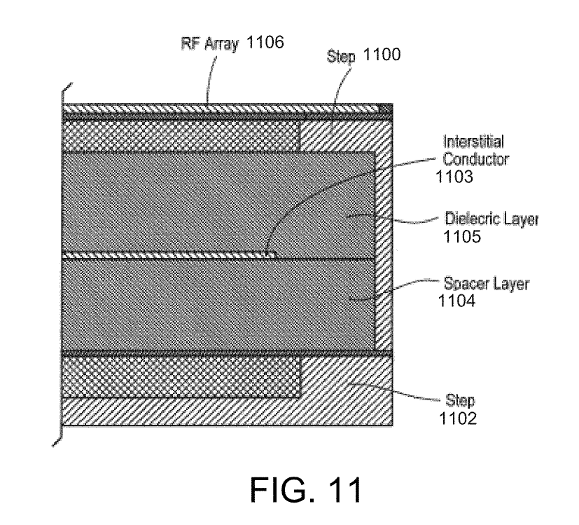

The antenna structure of FIG. 6A may include sides 607 and 608 angled to cause a travelling wave feed from coax pin 601 to be propagated from an area below interstitial conductor 603 (e.g., in a spacer layer 604) to an area above interstitial conductor 603 (e.g., in a dielectric layer 605) via reflection. In one embodiment, the angle of sides 607 and 608 are at 45° angles. In an alternative embodiment, sides 607 and 608 could be replaced with a continuous radius to achieve the reflection. While FIG. 6A shows angled sides that have angle of 45 degrees, other angles that accomplish signal transmission from lower level feed to upper level feed may be used. That is, given that the effective wavelength in the lower feed will generally be different than in the upper feed, some deviation from the ideal 45° angles could be used to aid transmission from the lower to the upper feed level. For example, in another embodiment, the 45° angles are replaced with a single step such as shown in FIG. 11. Referring to FIG. 11, steps 1100 and 1102 are shown on one end of the antenna around dielectric layer 1105, interstitial conductor 1103, and spacer layer 1104. Step structures similar to steps 1100 and 1102 may also be at the other ends of these layers. An RF array 1106 (e.g., similar in function to RF array 606) may be disposed above dielectric layer 1105.

In operation, when a feed wave is fed in from coaxial pin 601, the wave travels outward concentrically oriented from coaxial pin 601 in the area between ground plane 602 and interstitial conductor 603. The concentrically outgoing waves may be reflected by sides 607 and 608 and travel inwardly in the area between interstitial conductor 603 and RF array 606. The reflection from the edge of the circular perimeter causes the wave to remain in phase (i.e., it is an in-phase reflection). The travelling wave may be slowed by dielectric layer 605. At this point, the travelling wave starts interacting and exciting with elements in RF array 606 to obtain the desired scattering. To terminate the travelling wave, a termination 609 may be included in the antenna at the geometric center of the antenna. In one embodiment, termination 609 comprises a pin termination (e.g., a 50Ω pin). In another embodiment, termination 609 comprises an RF absorber that terminates unused energy to prevent reflections of that unused energy back through the feed structure of the antenna. These could be used at the top of RF array 606.

In one embodiment, a conducting ground plane 602 and interstitial conductor 603 are parallel to each other. A distance between ground plane 602 and interstitial conductor 603 may be in a range of 0.1″-0.15″, for example. This distance may be λ/2, where λ is the wavelength of the travelling wave at the frequency of operation. In one embodiment, spacer 604 may be a foam or air-like spacer—e.g., comprising a plastic spacer material. One purpose of dielectric layer 605 may be to slow the travelling wave relative to free space velocity. In one embodiment, dielectric layer 605 slows the travelling wave by 30% relative to free space. In one embodiment, the range of indices of refraction that are suitable for beam forming are 1.2-1.8, where free space has by definition an index of refraction equal to 1. A material with distributed structures may be used as dielectric 605, such as periodic sub-wavelength metallic structures that may be machined or lithographically defined, for example. An RF-array 606 may be on top of dielectric 605. In one embodiment, the distance between interstitial conductor 603 and RF-array 606 is 0.1″-0.15″. In another embodiment, this distance may be λ_{eff}/2, where λ_{eff} is the effective wavelength in the medium at the design frequency.

FIG. 6B illustrates another example of an antenna structure that is provided by a communication device according to an embodiment. Such an antenna structure may be included in one of antenna panels 124, 160, 310, 352, 354, etc., for example. Referring to FIG. 6B, a ground plane 610 may be substantially parallel to a dielectric layer 612 (e.g., a plastic layer, etc.). RF absorbers 619 (e.g., resistors) couple the ground plane 610 to a RF array 616 disposed on dielectric layer 612. A coaxial pin 615 (e.g., 50Ω) feeds the antenna.

In operation, a feed wave is fed through coaxial pin 615 and travels concentrically outward and interacts with the elements of RF array 616. The cylindrical feed in both the antennas of FIGS. 6A and 6B improves the service angle of the antenna. Instead of a service angle of plus or minus forty five degrees azimuth (±45° Az) and plus or minus twenty five degrees elevation (±25° El), in one embodiment, the antenna system has a service angle of seventy five degrees (75°) from the bore sight in all directions. As with any beam forming antenna comprised of many individual radiators, the overall antenna gain is dependent on the gain of the constituent elements, which themselves may be angle-dependent. When using common radiating elements, the overall antenna gain typically decreases as the beam is pointed further off bore sight. At 75° off bore sight, significant gain degradation of about 6 dB is expected.

Embodiments of the antenna having a cylindrical feed solve one or more problems. These include dramatically simplifying the feed structure compared to antennas fed with a corporate divider network and therefore reducing total required antenna and antenna feed volume; decreasing sensitivity to manufacturing and control errors by maintaining high beam performance with coarser controls (extending all the way to simple binary control); giving a more advantageous side lobe pattern compared to rectilinear feeds because the cylindrically oriented feed waves result in spatially diverse side lobes in the far field; and allowing polarization to be dynamic, including allowing left-hand circular, right-hand circular, and linear polarizations, while not requiring a polarizer.

RF array 606 of FIG. 6A and/or RF array 616 of FIG. 6B may each include a respective wave scattering subsystem that includes a group of patch antennas (i.e., scatterers) that act as radiators. This group of patch antennas may comprise an array of scattering metamaterial elements. In one embodiment, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor.

In one embodiment, a liquid crystal (LC) is injected in the gap around the scattering element. Liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) may be controlled by adjusting the bias voltage across the liquid crystal. Using this property, the liquid crystal acts as an on/off switch for the transmission of energy from the guided wave to the CELC. When switched on, the CELC emits an electromagnetic wave like an electrically small dipole antenna.

Controlling the thickness of the LC increases the beam switching speed. A fifty percent (50%) reduction in the gap between the lower and the upper conductor (the thickness of the liquid crystal) results in a fourfold increase in speed. In another embodiment, the thickness of the liquid crystal results in a beam switching speed of approximately fourteen milliseconds (14 ms). In one embodiment, the LC is doped to improve responsiveness so that a seven millisecond (7 ms) requirement may be met.

The CELC element is responsive to a magnetic field that is applied parallel to the plane of the CELC element and perpendicular to the CELC gap complement. When a voltage is applied to the liquid crystal in the metamaterial scattering unit cell, the magnetic field component of the guided wave induces a magnetic excitation of the CELC, which, in turn, produces an electromagnetic wave in the same frequency as the guided wave. The phase of the electromagnetic wave generated by a single CELC may be selected by the position of the CELC on the vector of the guided wave. Each cell generates a wave in phase with the guided wave parallel to the CELC. Because the CELCs are smaller than the wave length, the output wave has the same phase as the phase of the guided wave as it passes beneath the CELC.

In one embodiment, the cylindrical feed geometry of this antenna system allows the CELC elements to be positioned at forty five degree (45°) angles to the vector of the wave in the wave feed. This position of the elements enables control of the polarization of the free space wave generated from or received by the elements. In one embodiment, the CELCs are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the CELCs are implemented with patch antennas that include a patch co-located over a slot with liquid crystal between the two. In this respect, the metamaterial antenna acts like a slotted (scattering) wave guide. With a slotted wave guide, the phase of the output wave depends on the location of the slot in relation to the guided wave.

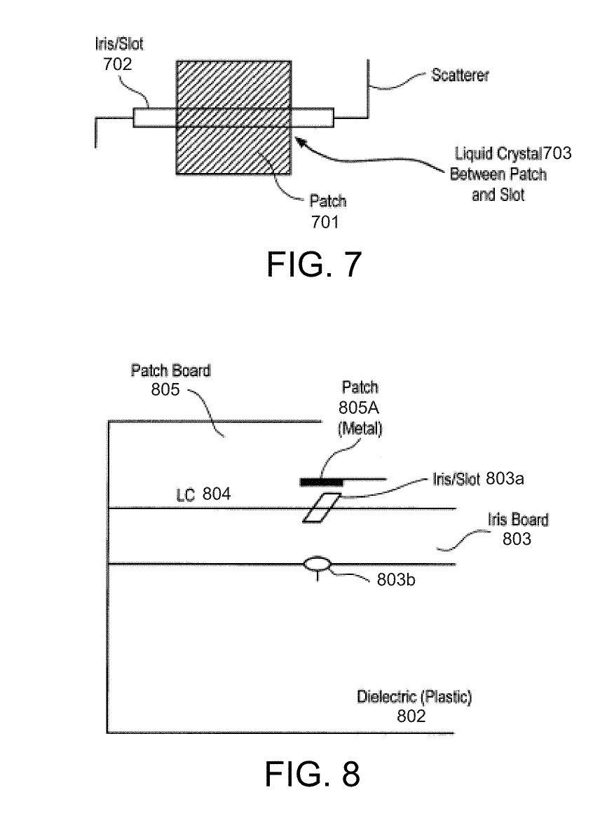

FIG. 7 illustrates a top view a patch antenna, or scattering element, which may be a component of a communication device according to another embodiment. Such a patch antenna, or scattering element, may be included in one of antenna panels 124, 160, 310, 352, 354, etc., for example. Referring to FIG. 7, the patch antenna may comprise a patch 701 collocated over a slot 702 with liquid crystal (LC) 703 in between patch 701 and slot 702.

FIG. 8 illustrates a side view of a patch antenna that is part of a cyclically fed antenna system according to an embodiment. One of antenna panels 124, 160, 310, 352, 354 (for example) may include the cyclically fed antenna system shown in FIG. 8.

Referring to FIG. 8, the patch antenna may be above dielectric 802 (e.g., a plastic insert, etc.) that, for example, is above the interstitial conductor 603 of FIG. 6A (or a ground conductor such as in the case of the antenna in FIG. 6B). An iris board 803 may comprise a ground plane (conductor) with a number of slots, such as slot 803a on top of and over dielectric 802. Below slot 803a is a corresponding circular opening 803b. A slot may be referred to herein as an iris. In one embodiment, the slots in iris board 803 are created by etching. Note that in one embodiment, the highest density of slots, or the cells of which they are a part, is λ/2. In one embodiment, the density of slots/cells is λ/3 (i.e., 3 cells per λ). Note that other densities of cells may be used.

A patch board 805 containing a number of patches, such as patch 805a, may be located over the iris board 803, separated by an intermediate dielectric layer. Each of the patches, such as patch 805a, may be co-located with one of the slots in iris board 803. In one embodiment, the intermediate dielectric layer between iris board 803 and patch board 805 is a liquid crystal substrate layer 804. The liquid crystal acts as a dielectric layer between each patch and its colocated slot. Note that substrate layers other than LC may be used. In one embodiment, patch board 805 comprises a printed circuit board (PCB), and each patch comprises metal on the PCB, where the metal around the patch has been removed. In one embodiment, patch board 805 includes vias for each patch that is on the side of the patch board opposite the side where the patch faces its co-located slot. The vias are used to connect one or more traces to a patch to provide voltage to the patch. In one embodiment, matrix drive is used to apply voltage to the patches to control them. The voltage is used to tune or detune individual elements to effectuate beam forming.

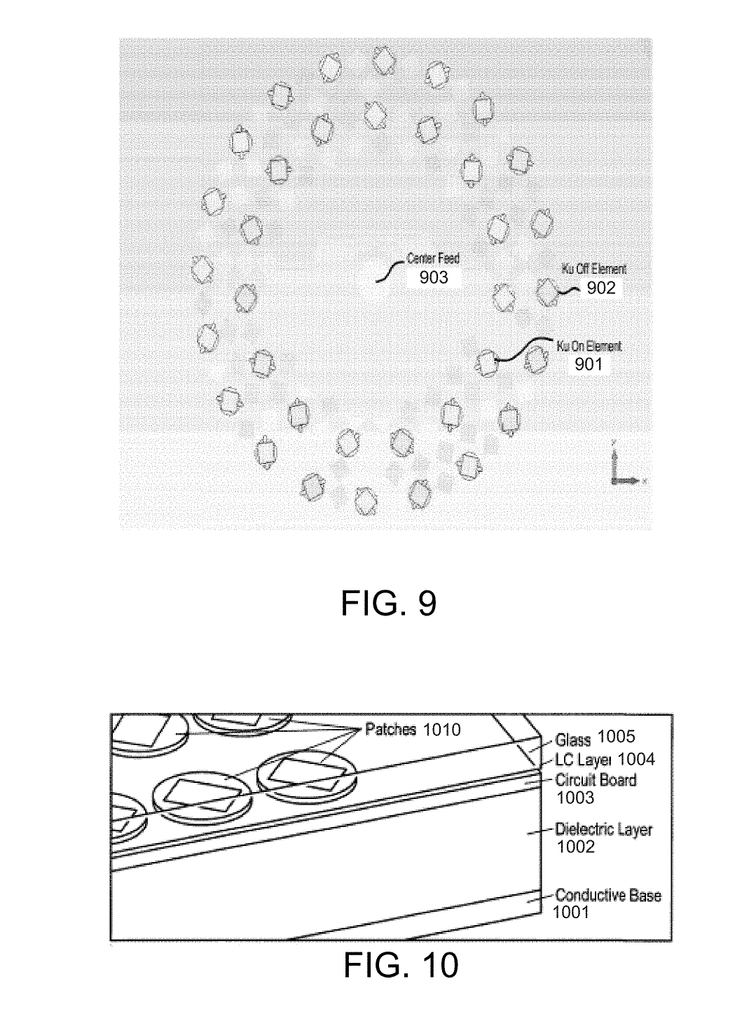

FIG. 9 illustrates a dual reception antenna showing receive antenna elements of a communication device according to an embodiment. One of antenna panels 124, 160, 310, 352, 354 (for example) may include an arrangement of antenna elements such as that shown in FIG. 9. In an embodiment, a dual receive antenna is a Ku receive-Ka receive antenna. Referring to FIG. 9, a slotted array of Ku antenna elements is shown. A number of Ku antenna elements are shown either off or on. For example, the aperture shows Ku on element 901 and Ku off element 902. Also shown in the aperture layout is center feed 903. Also, as shown, in one embodiment, the Ku antenna elements are positioned or located in circular rings around center feed 903 and each includes a slot with a patch co-located over the slot. In one embodiment, each of the slot slots is oriented either +45 degrees or −45 degrees relative to the cylindrical feed wave emanating from center feed 903 and impinging at a central location of each slot.

In one embodiment, patches may be deposited on a glass layer (e.g., a glass typically used for LC displays (LCDs) such as, for example, Corning Eagle glass), instead of using a circuit patch board. FIG. 10 illustrates a portion of a cylindrically fed antenna that includes a glass layer that contains the patches. One of antenna panels 124, 160, 310, 352, 354 (for example) may include the cyclically fed antenna of FIG. 10.

Referring to FIG. 10, the antenna includes conductive base or ground layer 1001, dielectric layer 1002 (e.g., plastic), iris board 1003 (e.g., a circuit board) containing slots, a liquid crystal substrate layer 1004, and a glass layer 1005 containing patches 1010. In one embodiment, the patches 1010 have a rectangular shape. In one embodiment, the slots and patches are positioned in rows and columns, and the orientation of patches is the same for each row or column while the orientation of the co-located slots are oriented the same with respect to each other for rows or columns, respectively.

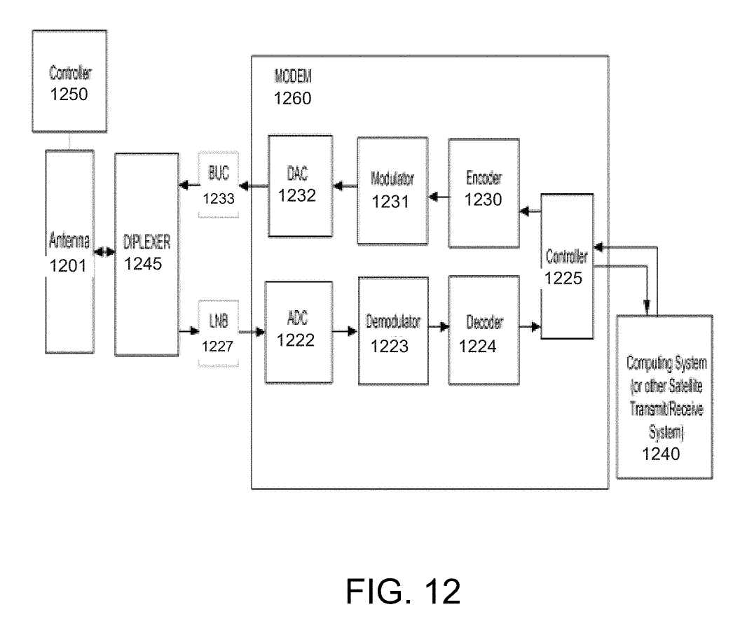

FIG. 12 is a block diagram of a communication system having transmit and receive paths according to an embodiment. The communication system of FIG. 12 may include features of system 100, for example. For example, the communication system may include one of devices 120, 150, 300, 350, etc. While one transmit path and one receive path are shown, the communication system may include only one of a receive path and a transmit path or, alternatively, may include more than one transmit path and/or more than one receive path.

Referring to FIG. 12, antenna 1201 includes one or more antenna panels operable to transmit and receive satellite communications—e.g., simultaneously at different respective frequencies. In one embodiment, antenna 1201 is coupled to diplexer 1245. The coupling may be by one or more feeding networks. In the case of a radial feed antenna, diplexer 1245 may combine the two signals—e.g., wherein a connection between antenna 1201 and diplexer 1245 includes a single broad-band feeding network that can carry both frequencies.

Diplexer 1245 may be coupled to a low noise block down converter (LNBs) 1227 which is to perform a noise filtering function and a down conversion and amplification function—e.g., including operations adapted from techniques known in the art. In one embodiment, LNB 1227 is in an out-door unit (ODU). In another embodiment, LNB 1227 is integrated into the antenna apparatus. LNB 1227 may be coupled to a modem 1260, which may be further coupled to computing system 1240 (e.g., a computer system, modem, etc.).

Modem 1260 may include an analog-to-digital converter (ADC) 1222, which may be coupled to LNB 1227, to convert the received signal output from diplexer 1245 into digital format. Once converted to digital format, the signal may be demodulated by demodulator 1223 and decoded by decoder 1224 to obtain the encoded data on the received wave. The decoded data may then be sent to controller 1225, which sends it to computing system 1240.

Modem 1260 may additionally or alternatively include an encoder 1230 that encodes data to be transmitted from computing system 1240—e.g., the encoding to convert the data from a data format compatible with one communication protocol to a different data format compatible with another communication protocol. The encoded data may be modulated by modulator 1231 and then converted to analog by digital-to-analog converter (DAC) 1232. The analog signal may then be filtered by a BUC (up-convert and high amplify) 1233 and provided to one port of diplexer 1233. In one embodiment, BUC 1233 is in an out-door unit (ODU). Diplexer 1245 may support operations adapted from conventional interconnect techniques to provide the transmit signal to antenna 1201 for transmission.

Controller 1250 may control antenna 1201, including controller 1250 transmitting signals to configure beam steering, beamforming, frequency tuning and/or other operational characteristics of one or more antenna elements. In some embodiments, controller 1250 includes circuitry operable to actively searching for, tracking and/or otherwise automatically acquiring a satellite signal—e.g., including signal detection operations adapted from conventional satellite communication techniques. Note that the full duplex communication system shown in FIG. 12 has a number of applications, including but not limited to, internet communication, vehicle communication (including software updating), etc.

Techniques and architectures for providing satellite communication functionality in a motor vehicle are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A communication device comprising:
a housing extending around a volume, wherein a thickness of the housing along a first line of direction is equal to or less than five inches;
an antenna panel disposed in the volume, the antenna panel including one or more holographic antenna elements configured to participate in a communication of a signal via a first side of the communication device, wherein the first line of direction is orthogonal to a first plane and a portion of the first side;
one or more hardware interfaces each disposed on a respective side of the housing other than the first side, the one or more hardware interfaces to couple the communication device to a power supply of a motor vehicle; and
control logic comprising circuitry coupled to operate the antenna panel based on a voltage provided by the power supply, including the control logic to steer a beam generated by the one or more holographic antenna elements.

2. The communication device of claim 1, wherein the one or more holographic antenna elements to participate in the communication includes the one or more holographic antenna elements to transmit or receive the signal in a frequency range which includes frequencies greater than 7.5 GigaHertz.

3. The communication device of claim 1, further comprising one or more mounting structures to facilitate connection of the communication device between an exterior surface of the motor vehicle and an interior surface of the motor vehicle.

4. The communication device of claim 1, wherein a portion of the first side is curved in a direction away from the first plane.

5. The communication device of claim 4, wherein an exterior side of the communication device is curved, the exterior side of the communication device opposite the first side.

6. The communication device of claim 1, the one or more hardware interfaces further to connect the communication device to one or more signal lines of the motor vehicle.

7. The communication device of claim 1, the one or more hardware interfaces further to couple the communication device to a waveguide of the motor vehicle.

8. The communication device of claim 1, further comprising a wireless modem to communicate wirelessly with a mobile device located in the motor vehicle.

9. The communication device of claim 1, further comprising:
an encoder to encode data to be transmitted from the communication device;
a modulator to generate a modulated signal based on the encoded data; and
a digital-to-analog converter to convert the modulated signal into an analog signal, the digital-to-analog converter to provide the analog signal to the antenna panel.

10. The communication device of claim 1, further comprising
an analog-to-digital converter coupled to receive a modulated signal from the antenna panel, the analog-to-digital converter to convert a modulated signal into a digital signal;
a demodulator to generate encoded data based on the modulated signal; and
a decoder to decode the encode data.

11. A system comprising:
a motor vehicle comprising a power supply and an interconnect; and
a communication device disposed between an interior surface of the motor vehicle and an exterior surface of the motor vehicle, the communication device comprising:
a housing extending around a volume, wherein a thickness of the housing along a first line of direction is equal to or less than five inches;
an antenna panel disposed in the volume, the antenna panel including one or more holographic antenna elements configured to participate in a communication of a signal via a first side of the communication device, wherein the first line of direction is orthogonal to a first plane and a portion of the first side;
one or more hardware interfaces each disposed on a respective side of the housing other than the first side, wherein the communication device is coupled to the power supply via the one or more hardware interfaces and the interconnect; and
control logic comprising circuitry coupled to operate the antenna panel based on a voltage provided by the power supply, including the control logic to steer a beam generated by the one or more holographic antenna elements.

12. The system of claim 11, wherein the one or more holographic antenna elements to participate in the communication includes the one or more holographic antenna elements to transmit or receive the signal in a frequency range which includes frequencies greater than 7.5 GigaHertz.

13. The system of claim 11, the communication device further comprising one or more mounting structures to facilitate connection of the communication device between an exterior surface of the motor vehicle and an interior surface of the motor vehicle.

14. The system of claim 11, wherein the first side is curved.

15. The system of claim 14, wherein an exterior side of the communication device is curved, the exterior side of the communication device opposite the first side.

16. The system of claim 11, the one or more hardware interfaces further to connect the communication device to one or more signal lines of the motor vehicle.

17. The system of claim 11, the one or more hardware interfaces further to couple the communication device to a waveguide of the motor vehicle.

18. The system of claim 11, the communication device further comprising a wireless modem to communicate wirelessly with a mobile device located in the motor vehicle.

19. The system of claim 11, the communication device further comprising:
an encoder to encode data to be transmitted from the communication device;
a modulator to generate a modulated signal based on the encoded data; and
a digital-to-analog converter to convert the modulated signal into an analog signal, the digital-to-analog converter to provide the analog signal to the antenna panel.

20. The system of claim 11, the communication device further comprising
an analog-to-digital converter coupled to receive a modulated signal from the antenna panel, the analog-to-digital converter to convert a modulated signal into a digital signal;
a demodulator to generate encoded data based on the modulated signal; and
a decoder to decode the encode data.
